(19) United States
(12) Patent Application Publication
(10) Pub. No.: US 2007/0202435 A1
(43) Pub. Date: Aug. 30, 2007

(54) Methods of forming optical waveguides

(75) Inventors: James G. Shelnut, Lancaster, MA (US); Nicola Pugliano, Grafton, MA (US)

Correspondence Address: Rohm and Haas Electronic Materials LLC, 455 Forest Street, Marlborough, MA, 01752, US

(73) Assignee: Rohm and Haas Electronic Materials LLC, Marlborough, MA (US)

(21) Appl. No.: 11/646,681

(22) Filed: Dec. 28, 2006

Related U.S. Application Data
(60) Provisional application No. 60/754,951, filed on Dec. 29, 2005.

(51) Int. Cl. G03C 1/00

(52) U.S. Cl. 430/270.1

(57) ABSTRACT

Provided are photosensitive compositions which are suitable for use in forming optical waveguides. The compositions include a polymer having units of the formula (RSiO_{1.5}), wherein R is a substituted or unsubstituted organic group, and a photoactive component for altering the solubility of the polymer upon exposure to actinic radiation. The photoactive component is non-ionic and has an associated wavelength of maximum absorption of greater than 300 nm. Also provided are methods of forming optical waveguides as well as optical waveguides. The compositions, methods and optical waveguides have particular use in the formation of printed wiring boards having electrical and optical functionality.

The present invention relates generally to the optoelectronics field, and more specifically, to compositions useful in forming optical waveguides and other optical components. In addition, the present invention relates to methods of forming optical waveguides and to optical waveguides formed from such compositions.

The incorporation of polymeric optical layers in the form of embedded optical waveguides into printed wiring boards is known. For example, U.S. Pat. Nos. 6,731,857 and 6,842,577, to Shelnut et al, disclose embedded optical waveguides formed using silsesquioxane chemistry on an electronic substrate such as a printed wiring board substrate or a semiconductor wafer. The optical waveguides include a core and a clad surrounding the core, with optical radiation propagating in the core due to its higher index of refraction as compared to the clad. Embedded or planar optical waveguides are typically formed by coating a bottom clad layer over a substrate, coating a core layer over the bottom clad layer, patterning the core layer to form a core structure, and forming a top clad layer over the bottom clad layer and core structure. The aforementioned documents disclose use of a photoimageable core layer for forming the waveguide core structure, whereby the core layer may be patterned using standard photolithographic exposure and development techniques.

Photoimageable compositions used in the formation of optical waveguides employ a polymeric component and a photoactive component that is sensitive to light. Commonly used photoactive components are photoacid generators (PAGs), typical of which are onium salts. These are generally hypervalent sulfur or iodine organic substituted salts, whose counter ion becomes an acid after exposure to actinic radiation. The acid generated in a layer of the photoimageable composition catalyzes a reaction to bring about a change in solubility of those regions exposed to light. For example, in the case of a negative-acting material, the acid causes cross-linking of the polymer component in the exposed regions which results in decreased solubility of such cross-linked material in a developer solution.

A compound's extinction coefficient provides a measure of its photosensitivity at maximum absorption, according to Beer's law. The wavelength at the compound's maximum absorption is that which results in the highest and most efficient photoreaction. The maximum absorption for commonly used onium salts is below 300 nm. In some instances, depending on the particular substitutent on the onium salt, some “tailing” of the absorbance above 300 nm may occur. Owing to their relatively low wavelength of maximum absorptions, onium salt photoactive components are not ideal when using certain artwork materials. For example, soda-lime glass and polyester (e.g., polyethylene terephthalate or PET) artwork exhibit transmission cutoffs of approximately 300 nm. As such, wavelengths of approximately 300 nm and lower cannot pass through such artwork to the photoimageable material. As a result, the photo-efficiency of such PAGs is very low and large amounts of energy are required to generate a useful amount of acid. While quartz artwork readily transmits wavelengths less than 300 nm, the cost of such artwork becomes exorbitantly high where large substrates (e.g., 12×12 inches or larger) are required. Also, quartz artwork is fragile and subject to breakage.

In addition to the aforementioned light absorption issues of typical onium salts, some onium salts such as triphenylsulfonium trifluoromethylsulfonate are difficult to use as a result of their poor solubility in solvents such as propylene glycol monomethyl ether acetate. Still a further problem with the use of onium salts is their adverse impact on shelf life of the photoimageable compositions. In this regard, onium salts are relatively unstable and begin to break down into their acid components, causing premature reaction of the polymer component.

Photosensitive compositions and methods of forming optical waveguides which address one or more of the foregoing problems associated with the state of the art are therefore desired.

A first aspect of the invention provides photosensitive compositions suitable for use in forming optical waveguides. The compositions include a polymer having units of the formula (RSiO_{1.5}), wherein R is a substituted or unsubstituted organic group, and a photoactive component for altering the solubility of the polymer upon exposure to actinic radiation. The photoactive component is non-ionic and has an associated wavelength of maximum absorption of greater than 300 nm. In accordance with an exemplary composition, the photoactive component is a compound of the formula: 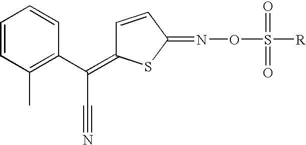
wherein R is a substituted or unsubstituted organic group. R may be, for example, C1-C10 n-alkyl such as n-propyl or n-octyl, Camphor or p-tolyl.

A second aspect of the invention provides methods of forming optical waveguides. The methods involve: (a) forming over a substrate a layer of a photosensitive composition which includes: units of the formula (RSiO_{1.5}), wherein R is a substituted or unsubstituted organic group; and a photoactive component for altering the solubility of the polymer upon exposure to actinic radiation, wherein the photoactive component is non-ionic and has an associated wavelength of maximum absorption of greater than 300 nm; and (b) exposing the layer to actinic radiation having a wavelength greater than 300 nm.

A third aspect of the invention provides optical waveguides which may be formed from the above-described compositions and methods.

The present invention will be discussed with reference to the following drawing, in which:

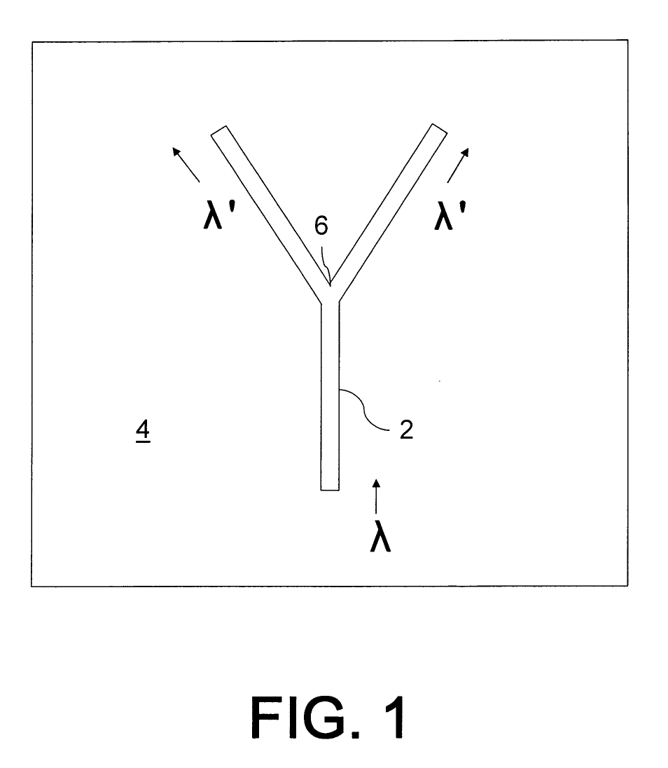

FIG. 1 illustrates an exemplary optical waveguide of an electronic device in accordance with one aspect of the invention.

The present invention provides photosensitive compositions which find use in forming optical waveguides and other optical components. Unless otherwise specified, amounts for components of the composition are given in weight % based on the composition absent any solvent. As used herein, the term “polymer” includes oligomers, dimers, trimers, tetramers and the like, and encompasses homopolymers and higher order polymers, i.e., polymers formed from two or more different monomer units and heteropolymers. The term “alkyl” refers to linear, branched and cycloalkyl groups, which are substituted or unsubstituted and can include heteroatoms in or on the chain. The term “aromatic” refers to aromatic groups, which are substituted or unsubstituted and can include heterocycles. The term “aralkyl” refers to groups containing both alkyl and aryl constituents, which are substituted or unsubstituted and can include heteroatoms or heterocycles, respectively. The terms “a” and “an” mean “one or more” unless otherwise indicated. The term “in a dried state” means a composition containing 10 wt % or less of a solvent, based on the entire composition. “nm” means nanometers.

The compositions according to the present invention include a polymer having units of the formula (RSiO_{1.5}), wherein R is a substituted or unsubstituted organic group, and a photoactive component for altering the solubility of the polymer upon exposure to actinic radiation. The photoactive component is non-ionic and has an associated wavelength of maximum absorption of greater than 300 nm.

The polymer component may be present in the composition in an amount of from 1 to 99.5 wt %, for example from 60 to 98.5 wt %. Exemplary organic groups for R include substituted and unsubstituted alkyl, aryl, aralkyl and heterocyclic groups. The alkyl groups can be straight chain, branched or cyclic having, for example, from 1 to 20 carbon atoms such as methyl, ethyl, propyl, isopropyl, t-butyl, t-amyl, octyl, decyl, dodecyl, cetyl, stearyl, cyclohexyl, and 2-ethylhexyl. The alkyl groups can be substituted. “Substituted” means that one or more hydrogen atoms on the side chain groups is replaced by another substitutent group, for example, hydroxyl, deuterium, halogen such as fluorine, bromine, and chlorine, (C₁-C₆)alkyl, (C₁-C₆)haloalkyl, (C₁-C₁₀)alkoxy, (C₁-C₁₀)alkylcarbonyl, (C₁-C₁₀)alkoxycarbonyl, (C₁-C₁₀)alkylcarbonyloxy, alkylamine, alkylsulfur containing materials, and the like. The alkyl groups can be substituted with heteroatoms in and/or on the alkyl chain, for example, or can be cyclic groups such as cyclopentyl, cyclohexyl, norbonyl, adamantly, piperidinyl, tetrahydrofuranyl and tetrahydrothiophenyl groups. Exemplary aryl groups include those having from 6 to 20 carbon atoms, for example, from 6 to 15 carbon atoms, such as phenyl, tolyl, benzyl, 1-naphthyl, 2-naphthyl and 2-phenanthryl, and can be substituted with heteroatoms. Heterocyclic groups can be aromatic, for example, thiophene, pyridine, pyrimidine, pyrrole, phosphole, arsole, and furane. Typical for R are substituted and unsubstituted methyl, ethyl, propyl, cyclopentyl, cyclohexyl, benzyl, phenyl, adamantyl groups, and combinations thereof.

The polymer can take the form of a copolymer or higher order polymer, either random- or block-type. The polymer can include, for example, one or more additional silicon-containing unit, with the proportions for each unit ranging from 1 to 85 wt %, for example, from 15 to 80 wt % or from 25 to 60 wt %, or from 25 to 50 wt %, based on the polymer. The additional units can, for example, be represented as siloxanes, silsesquioxanes, cage siloxanes and/or combinations thereof. For example, the polymer can further include polymerized units of the formula (R¹SiO_{1.5}), wherein R¹ is a substituted or unsubstituted organic group as described above with respect to R and which is different than R. One of R and R¹ can, for example, be chosen from substituted or unsubstituted alkyl groups, and the other of R and R¹ chosen from substituted or unsubstituted aryl groups. The polymer can be, for example, an alkyl silicon polymer such as a copolymer containing methyl silsesquioxane units and butyl silsesquioxane units; an aryl silicon polymer such as a copolymer containing phenyl silsesquioxane units and trifluoromethylphenyl-silsesquioxane units or an aralkyl silicon copolymer such as a copolymer containing methyl and phenyl silsesquioxane units.

The polymer can further, optionally include one or more siloxane units, for example, phenyl or methyl-substituted siloxanes. The formed polymer can contain, for example: methyl silsesquioxane units and tetramethyldisiloxane units; phenyl silsesquioxane units and hexamethyltrisiloxane units; methyl and phenyl silsesquioxane units, and tetramethyldisiloxane units; or phenyl silsesquioxane units and hexamethyltrisiloxane units.

The polymer materials can be prepared by known methods with readily available starting materials. For example, the polymer may be the product of condensation reaction of reactants of the formula RSi(OR²)₃, wherein R is as defined above, and R² is chosen from substituted and unsubstituted aliphatic, aromatic, and aralkyl groups. One or more additional types of units may be includes in the polymer by use of additional reactants for the condensation reaction. For example, the reactants may include additional, different reactants of the formula RSi(OR²)₃ and a reactant of the formula R⁴O(R⁵₂Si—O)ₓOR⁶, wherein R⁴, R⁵ and R⁶ are chosen from substituted and unsubstituted aliphatic, aromatic, and aralkyl groups, and x is 2 or more.

The polymer component is typically present in the composition in an amount of from 1 to 99.5 wt %, for example from 60 to 98.5 wt %. The polymers may contain a wide range of repeating units, either random or block. The polymer units useful in the present invention may have, for example, from 5 to 150 repeating units, typically from about 10 to 35 repeating units. Thus, the polymer may vary widely in molecular weight. Typically, the polymers have a weight average molecular weight (M_{w}) of from about 500 to 15,000, more typically from about 1000 to 10,000, even more typically from about 1000 to 5000.

The photoactive components used in the photosensitive compositions are non-ionic and have a maximum absorbance for actinic radiation at a wavelength greater than 300 nm, for example, greater than 315 nm, or greater than 350 nm such as 365 nm (i-line). The non-ionic nature of the photoactive components results in improved solubility in common solvents as compared with the typically used onium salts. In addition, the absorption characteristics of these components allows for the use of artwork formed from materials such as soda-lime glass and PET which exhibit transmission cutoffs of approximately 300 nm. Upon activation, the photoactive component alters the solubility of the composition in a dried state such that the composition may be developed in a developer solution. In the case of a negative working material, the photoactive component catalyzes coupling of exposed portions of the polymer composition, rendering the coupled portions insoluble in a developer solution. Exemplary photoactive components are of the formula: 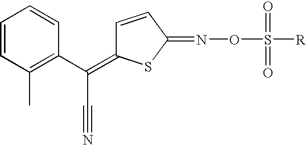
wherein R is a substituted or unsubstituted organic group. R may be, for example, an alkyl group such as a C3-C10 n-alkyl such as n-propyl or n-octyl, Camphor or p-tolyl. Such compounds are commercially available, for example, from Ciba Specialty Chemicals Inc, Basel Switzerland. The amount of the photoactive component useful in the present invention, in the case of a negative working material, is any amount sufficient to catalyze polymerization of the polymer component upon exposure to the actinic radiation to render the coupled portion insoluble in a developer solution. The photoactive component is present in the composition in an amount of from 0.01 to 10 wt %.

Other additives may optionally be present in the compositions of the invention including, but not limited to, flexibilizing agents, surface leveling agents, wetting agents, antifoam agents, adhesion promoters, thixotropic agents, and the like. Such additives are well known in the art for coating compositions. The use of surface leveling agents, for example silicone-base oils such as SILWET L-7604 silicone-base oil available from Dow Chemical Company, in the inventive compositions can be used. It will be appreciated that more than one additive may be combined in the compositions of the present invention. For example, a wetting agent may be combined with a thixotropic agent. Such optional additives are commercially available from a variety of sources. The amounts of such optional additives to be used in the present compositions will depend on the particular additive and desired effect, and are within the ability of those skilled in the art. Such other additives are typically present in the composition in an amount of less than 5 wt %, for example less than 2.5 wt %.

The compositions of the invention can optionally contain one or more organic cross-linking agents. Cross-linking agents include, for example, materials which link up components of the composition in a three-dimensional manner. Aromatic or aliphatic cross-linking agents that react with the silicon-containing polymer are suitable for use in the present invention. Such organic cross-linking agents will cure to form a polymerized network with the silicon-containing polymer, and reduce solubility in a developer solution. Such organic cross-linking agents may be monomers or polymers. It will be appreciated by those skilled in the art that combinations of cross-linking agents may be used in the present invention. Suitable organic cross-linking agents useful in the present invention include, but are not limited to: amine containing compounds, epoxy containing materials, compounds containing at least two vinyl ether groups, allyl substituted aromatic compounds, and combinations thereof. Typical cross-linking agents include amine containing compounds and epoxy containing materials. The amine containing compounds useful as cross-linking agents in the present invention include, but are not limited to: melamine monomers, melamine polymers, alkylolmethyl melamines, benzoguanamine resins, benzoguanamine-formaldehyde resins, urea-formaldehyde resins, glycoluril-formaldehyde resins, and combinations thereof. It will be appreciated by those skilled in the art that suitable organic cross-linker concentrations will vary with factors such as cross-linker reactivity and specific application of the composition. When used, the cross-linking agent(s) is typically present in the composition in an amount of from 0.1 to 50 wt %, for example, from 0.5 to 25 wt % or from 1 to 20 wt %.

The present compositions can optionally and typically contain one or more solvents. Such solvents aid in formulating the present compositions and in coating the present compositions on a substrate. A wide variety of solvents may be used. Suitable solvents include, but are not limited to, esters such as methyl cellosolve acetate, ethyl cellosolve acetate, propylene glycol monomethyl ether acetate, dipropylene glycol monomethyl ether acetate, dibasic esters, glycol ethers, such as ethylene glycol monomethyl ether, propylene glycol monomethyl ether, dipropylene glycol monomethyl ether; carbonates such as propylene carbonate, γ-butyrolactone, esters such as ethyl lactate, n-amyl acetate and n-butyl acetate, alcohols such as n-propanol, iso-propanol, ketones such as cyclohexanone, methyl isobutyl ketone, diisobutyl ketone and 2-heptanone, lactones such as γ-butyrolactone and γ-caprolactone, ethers such as diphenyl ether and anisole, hydrocarbons such as mesitylene, toluene and xylene, and heterocyclic compounds such as N-methyl-2-pyrrolidone, N,N′-dimethylpropyleneurea, or mixtures thereof.

The compositions of the present invention can be prepared by combining, in admixture, the polymer component, the photoactive component and other optional components in any order.

In accordance with a further aspect of the invention, the photosensitive compositions of the invention may be used to form dry-films which find use, for example, as an optical layer or a photoresist. Thus, the dry-films are suitable for use in forming the waveguide structures described below or a photoresist pattern. The dry-films include a releasable carrier substrate and a photosensitive polymeric layer over the carrier substrate. The polymeric layer is formed from a composition as described above. The dry film typically includes a protective cover layer on the front surface of the dry-film over the polymeric layer.

The carrier substrate functions as a mechanical support for the polymeric layer and any other layers of the dry-film during manufacture, storage and subsequent processing. Suitable carrier substrate materials include, for example: polyethylene terephthalate (PET), which may be treated in various ways, for example, resin-coated, flame or electrostatic discharge-treated, or slip-treated; a paper such as polyvinyl alcohol-coated paper, crosslinked polyester-coated paper, polyethylene-coated paper, cellulose paper, or a heavy paper such as lithographic paper; nylon; glass; cellulose acetate; a synthetic organic resin; a polyolefin such as polypropylene; a polyimide; a polyurethane; a polyacrylate such as polymethylmethacrylate (PMMA); fiberboard; a metal such as copper, aluminum, tin, magnesium, zinc, nickel, or an alloy thereof; and a multilayered structure of two or more of these or other materials, for example, a copper-coated fiberboard or epoxy laminate. The carrier substrate typically has a thickness, for example, of from about 25 to 250 μm.

The protective cover layer provides protection to the polymeric layer, and is typically in the form of a removable film or sheet that may be peeled from the remainder of the dry-film. Adhesion of the protective cover layer to the polymeric layer is less than that of the carrier substrate to the polymeric layer. This allows for separation of the protective cover layer from the polymeric layer without also separating the polymeric layer from the carrier substrate. Suitable materials for the protective cover layer include, for example, polyolefins such as polyethylene and polypropylene, polyvinyl alcohol, and PET. The protective cover layer typically has a thickness of from about 10 to 100 μm. Optionally, the protective cover layer may include a first layer coated with a release layer which contacts the polymeric layer. Suitable release layer materials include, for example, thermally or photochemically cured silicones, polyvinyl stearate, polyvinyl carbamates, poly N-ethylperfluorooctyl sulfanamidoethyl methacrylate, poly(tetrafluorothylene), polypropylene, polymethyl methacrylate, polysiloxanes, polyamides, and other release materials such as those described in Satas, Handbook of Pressure Sensitive Adhesive Technology, 2^{nd} ed., Van Nostrand/Reinhold (1989).

The dry-films may be prepared, for example, by coating a composition as described above onto a carrier substrate, for example, by meniscus coating, spray coating, roller coating, wire roll coating, doctor blade coating, curtain coating and the like, typically to a dry thickness of from 5 to 150 microns. The coated carrier substrate may be dried, for example, by convection drying, infrared drying, air drying and the like, typically to a solvent content of from 0 to 10 wt %, typically less than 5 wt % or from 2 to 5 wt %, based on the polymeric layer. The carrier substrate may be in the form of discrete sheets, typically from 2 to 150 cm in width and from 2 to 150 cm in length, which may be coated and dried as sheets and stacked. The carrier sheet may further be in the form of a roll, typically from 2 to 150 cm in width and from 0.5 to 1000 meters in length, which may be coated and dried in a reel-to-reel format, commonly known as a web coating process. The protective cover layer may be applied, for example, by lamination with or without heat and/or pressure. The protective cover sheet is peeled away from the dry-film, and the dry-film is affixed to a substrate (e.g., electronic substrate), for example, by lamination. The polymeric layer may then be imaged and patterned in the case of a photosensitive composition or thermally cured in the case of a non-photosensitive material. Depending on its material of construction, the dry-film carrier substrate is removed from the polymeric layer before or after exposure.

In accordance with a further aspect of the invention, an optical waveguide may be formed from the above-described polymers and compositions. The waveguide includes a core and a clad. The core and/or the clad are formed from a composition such as described above. In one aspect of the invention, a waveguide is formed from the inventive composition by depositing core and cladding layers, wherein the cladding has a lower index of refraction as compared to the core.

The waveguides of the present invention may be manufactured as individual waveguides or as an array of waveguides. For purposes of example only, a method of forming an optical waveguide having clad and core structures formed from the inventive compositions will be described. A waveguide is formed by depositing core and first and second cladding layers. The clad of the final structure has a lower index of refraction as compared to the core. Particularly useful waveguides include a core having an index of refraction of from 1.4 to 1.7 and a cladding having an index of refraction of from 1.3 to 1.69.

Any substrate suitable for supporting a waveguide may be used in this aspect of the invention. Suitable substrates include, but are not limited to, substrates used in the manufacture of electronic devices such as printed wiring boards and integrated circuits. Particularly suitable substrates include laminate surfaces and copper surfaces of copper clad boards, copper foils, printed wiring board inner layers and outer layers, wafers used in the manufacture of integrated circuits such as silicon, gallium arsenide, and indium phosphide wafers, glass substrates including but not limited to liquid crystal display (“LCD”) glass substrates, and substrates that include dielectric coatings, cladding layers, and the like.

A first cladding layer can be formed on the substrate surface. The first cladding layer (as well as the other waveguide layers to be described) may be formed from the compositions of the invention or such compositions absent the photoactive component, by any technique including, but not limited to, screen printing, curtain coating, roller coating, slot coating, spin coating, flood coating, electrostatic spray, spray coating, or dip coating. When the compositions of the present invention are spray coated, a heated spray gun may optionally be used. The viscosity of the composition may be adjusted to meet the requirements for each method of application by viscosity modifiers, thixotropic agents, fillers and the like. The first cladding layer is typically deposited to a thickness in the dried state of from about 1 to 100 μm, for example, from about 10 to 50 μm.

The first cladding layer can be cured, for example, thermally or photolytically depending on the type of active component in the first cladding composition. The thermal curing temperature is typically from 90 to 300° C., for example from 90 to 220° C. Such curing typically occurs over a period of from five seconds to one hour. Such curing may be affected by heating the substrate in an oven or on a hot plate. Alternatively the waveguide clad can be flood exposed, for example, with 1 to 2 Joules/cm² of actinic radiation followed by the thermal cure from 90 to 300° C., for example from 90 to 220° C.

A core layer formed from a composition according to the invention is formed on the first clad layer. The core layer is typically coated to a thickness in the dried state of from about 1 to 100 μm, for example, from about 8 to 60 μm. The coated substrate is then soft cured, such as by baking, to remove solvent in the coating. Such curing may take place at various temperatures, depending upon the particular solvent chosen. Suitable temperatures are any that are sufficient to substantially remove any solvent present. The soft curing may be at any temperature from room temperature (25° C.) to 300° C., depending, for example, on the substrate and the thermal budget. Such curing can occur, for example, over a period of from 5 seconds to 60 minutes in an oven or on a hot plate.

After curing, the core layer is imaged by exposure to actinic radiation of a wavelength greater than 300 nm, for example, greater than 315 nm, or greater than 350 nm such as 365 nm. Such methods include, for example, contact imaging, projection imaging, and laser direct write imaging, including laser direct write imaging by multiphoton absorption. Multiphoton absorption can, if desired, be used to form 3-dimensional structures within the layer. The exposure pattern as defined, for example, by a photomask defines the geometry of the core waveguide, which is typically but not necessarily on the order of centimeters to meters in length, and microns to hundreds of microns in width. Following exposure, the composition can be post exposure cured, typically at a temperature of from 40 to 170° C. Curing time may vary but is generally from about 30 seconds to 1 hour.

The unexposed areas may be removed, such as by contact with a suitable developer, leaving only the exposed areas remaining on the substrate, thus forming defined core structures. The composition is advantageously developable in an aqueous developer solution. Suitable aqueous developers include, for example, alkali metal hydroxides such as sodium hydroxide and potassium hydroxide in water, as well as tetraalkylammonium hydroxide such as tetramethylammonium hydroxide, in water. Such developers are typically used in concentrations from 0.1 to 2N, for example, 0.15 to 1N, or 0.26 to 0.7N. Alternatively, the unexposed areas may be removed by contact with non-aqueous developers. Suitable developers include, for example, alcohols, such as C₁-C₁₀ alcohols and their isomers, C₁-C₁₀ ketones, C₁-C₁₀ esters, C₁-C₁₀ substituted or unsubstituted hydrocarbons, and combinations hereof. The developer solutions may optionally include one or more known surfactants, such as polyethylene glycol, alkyl sulfonates, and other surfactants well known in the art. The surfactant is typically present in the developer in an amount of from 0.01 to 3 wt %. Antifoaming agents may also be advantageously included in the developer.

Development may be at a variety of temperatures such as from room temperature to about 65° C., for example from 21 to 49° C. Development time with mild or aggressive agitation can be within ten minutes, for example, within five minutes, within two minutes, within one minute, or within 30 seconds. Development can take place, for example, in a static development chamber or on a conveyorized platform upon which developer is sprayed. Spray pressures can range from 5 to 40 psi, for example, from 10 to 25 psi.

Following development, the present waveguides may undergo a final cure step. The curing can, for example, include a flood exposure, for example, with 1 to 2 Joules/cm² of actinic radiation. Additionally, or alternatively, the waveguides may be heated at a temperature of from about 130° to 300° C. in air or an inert atmosphere such as nitrogen or argon.

Next, a second cladding layer can be formed as described above over the first cladding layer and core structure. The second cladding layer may be the same or different from the first cladding layer. The second cladding layer can be thermally activated and/or photo activated to provide a waveguide structure as described above with respect to the first clad layer. The second cladding layer is typically deposited to a dried thickness of from about 1 to 100 μm, for example, from about 10 to 50 μm.

Optical waveguides of the present invention possess excellent transparencies at a variety of wavelengths. Thus, the present optical waveguides may be used at, for example, 600 to 1700 nm. It will be appreciated that the present optical waveguides may be advantageously used at other wavelengths. Thus, the present optical waveguides are particularly suited for use in data communications and telecommunications applications.

The optical waveguides of the invention can be used in forming optoelectrical devices including, but not limited to, splitters, couplers, spectral filters, polarizers, isolators, multiplexers such as wavelength division multiplexing structures, amplifiers, attenuators, switches, and the like or, on a larger scale, in electronic devices such as printed wiring boards, integrated circuits, interconnects, and the like. FIG. 1 illustrates an exemplary waveguide of an electronic device in accordance with a further aspect of the invention. The device is an optical splitter that includes a waveguide core 2 formed on a first waveguide clad layer 4. A second clad layer is typically formed over the first clad layer and core. An input of signal wavelength λ is split at the Y-junction 6 into two light signals λ′ of equal wavelength but at a reduced power amplitude.

The present compositions are also particularly useful in manufacturing display devices including lenses as well as optical elements such as mirrors, prisms and connectors. As used herein, the term electronic device is intended to encompass optoelectronic devices, for example, those described above, as well as the aforementioned larger scale devices that include an optoelectronic device.

The following examples are intended to illustrate further various aspects of the present invention, but are not intended to limit the scope of the invention in any aspect. For purposes of the examples, amounts for the various components are given in weight % based on the entire composition including solvent.

### EXAMPLE 1

50 wt % propylene glycol monomethyl ether acetate, 49 wt % phenyl-methyl silsesquioxane (50:50), 0.99 wt % of Compound A in the table below, and 0.01 wt % Dow SILWET L-7604 silicone-base oil are combined in admixture. The composition is spin-coated at 2000 rpm onto a six-inch silicon dioxide-coated silicon wafer and soft-baked in air on a hot plate for two minutes at 90° C., to a thickness of 8 μm. Artwork defining the required waveguide is placed directly on the composition. The artwork includes patterns for forming waveguides of various dimensions and shapes, such as linear, branched, and curved shaped waveguides between 2 and 14 cm in length and 5 to 15 μm in width. 800 mJ/cm² of actinic radiation is applied to the construction followed by a post-exposure-bake in air at 90° C. for two minutes. The exposed wafer is dipped in a 0.7N sodium hydroxide developer solution held at 37.8° C. (100° F.) for 30 seconds. The wafer is then rinsed in de ionized water and dried. Optical waveguides are thereby formed.

### EXAMPLE 2

37 wt % ethyl lactate, 53 wt % of the condensation reaction product of 45 wt % phenyl-triethoxysilane, 45 wt % methyl-triethoxysilane, and 10 wt % dimethyl-diethoxysilane, 5 wt % of polydiethoxysiloxane, 4.99 wt % of Compound A in the table below, and 0.01 wt % Dow SILWET L-7604 silicone-base oil are combined in admixture. The composition is roller-coated onto an epoxy laminate, such as commonly used in printed wiring board manufacture, to a thickness of 50 μm and dried in air in a convection oven for 30 minutes at 90° C. Polyester artwork as described above, but with lines of 40 to 200 μm in width, is placed directly on the composition. 500 mJ/cm² of actinic radiation is applied to the construction followed by a post-exposure-bake in air at 90° C. for 30 minutes. The exposed structure is then dipped in a 0.7N sodium hydroxide developer solution held at 37.8° C. (100° F.) for 60 seconds. The laminate is rinsed in deionized water and dried. The resultant waveguides are hard-cured at 200° C. for 60 minutes in air in a convection oven. Optical waveguides are thereby formed.

### EXAMPLES 3-8

The procedures of Examples 1 and 2 are repeated, except group B, C and D in the table below are substituted for group A.

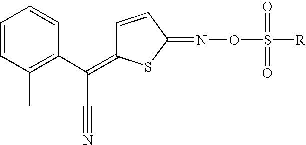

| Group (Examples) | R |
|---|---|
| A (Ex. 1-2) | n-propyl |
| B (Ex. 3-4) | n-octyl |
| C (Ex. 5-6) | Camphor |
| D (Ex. 7-8) | p-tolyl |

### EXAMPLE 9

50 wt % propylene glycol monomethyl ether acetate, 49 wt % phenyl-methyl silsesquioxane (40:60), 0.99 wt % of Compound A in the table above, and 0.01 wt % Dow SILWET L-7604 silicone-base oil are combined in admixture. The composition is spin-coated at 2000 rpm onto a six-inch silicon dioxide-coated silicon wafer and soft-baked in air on a hot plate for two minutes at 90° C., to a thickness of 8 μm. 500 mJ/cm² of actinic radiation is applied to the coated composition followed by hard-curing at 200° C. for 60 minutes in air in a convection oven. An optical clad layer is thereby formed. The composition and procedure of Example 1 is followed using the optical clad layer of this example in place of the silicon dioxide-coated silicon wafer to give a clad-core construction. The admixture of this example is spin coated at 2000 rpm onto the clad-core construction and soft-baked in air on a hot plate for two minutes at 90° C., to a thickness of 16 μm. 1000 mJ/cm² of actinic radiation is applied to the coated composition followed by hard-curing at 200° C. for 60 minutes in air in a convection oven. A clad-core-clad waveguide is thereby formed.

### EXAMPLE 10

37 wt % ethyl lactate, 53 wt % of the condensation reaction product of 35 wt % phenyl-triethoxysilane, 55 wt % methyl-triethoxysilane, and 10 wt % dimethyl-diethoxysilane, 5 wt % of polydiethoxysiloxane, 4.99 wt % of Compound A in the table above, and 0.01 wt % Dow SILWET L-7604 silicone-base oil are combined in admixture. The composition is roller-coated onto an epoxy laminate, such as commonly used in printed wiring board manufacture, to a thickness of 50 μm and dried in air in a convection oven for 30 minutes at 90° C. 500 mJ/cm² of actinic radiation is applied to the construction followed by a hard-cure at 200° C. for 60 minutes in air in a convection oven. An optical clad layer is thereby formed. The composition and procedure of Example 2 is followed using the optical clad layer of this example in place of the epoxy laminate to give a clad-core construction. The admixture of this example is roller coated onto the clad-core construction and dried in air in a convection oven for 30 minutes at 90° C. 1000 mJ/cm² of actinic radiation is applied to the construction followed by a hard-cure at 200° C. for 60 minutes in air in a convection oven. A clad-core-clad optical waveguide is thereby formed.

### EXAMPLES 11-16

The procedure of Examples 9 and 10 are repeated, except groups B, C and D in the table below are substituted for group A.

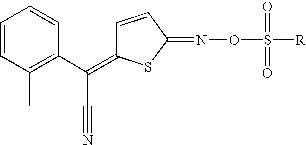

| Group (Examples) | R |
|---|---|
| A (Ex. 9-10) | n-propyl |
| B (Ex. 11-12) | n-octyl |
| C (Ex. 13-14) | Camphor |
| D (Ex. 15-16) | p-tolyl |

### EXAMPLES 17

50 wt % propylene glycol monomethyl ether acetate, 49 wt % phenyl-methyl silsesquioxane (40:60), 0.99 wt % of trimethylammonium para-toluene sulfonate, and 0.01 wt % Dow SILWET L-7604 silicone-base oil are combined in admixture. The composition is spin-coated at 2000 rpm onto a six-inch silicon dioxide-coated silicon wafer and soft-baked in air on a hot plate for two minutes at 90° C., to a thickness of 8 μm followed by hard-curing at 200° C. for 60 minutes in air in a convection oven. An optical clad layer is thereby formed. The composition and procedure of Example 1 is followed using the optical clad layer of this example in place of the silicon dioxide-coated silicon wafer to give a clad-core construction. The admixture of this example is spin coated at 2000 rpm onto the clad-core construction and soft-baked in air on a hot plate for two minutes at 90° C., to a thickness of 16 μm followed by hard-curing at 200° C. for 60 minutes in air in a convection oven. A clad-core-clad waveguide is thereby formed.

### EXAMPLES 18

37 wt % ethyl lactate, 53 wt % of the condensation reaction product of 35 wt % phenyl-triethoxysilane, 55 wt % methyl-triethoxysilane, and 10 wt % dimethyl-diethoxysilane, 5 wt % of polydiethoxysiloxane, 4.99 wt % of trimethylammonium para toluene sulfonate, and 0.01 wt % Dow SILWET L-7604 silicone-base oil are combined in admixture. The composition is roller-coated onto an epoxy laminate, such as commonly used in printed wiring board manufacture, to a thickness of 50 μm, followed by a hard-cure at 140° C. for 60 minutes in air in a convection oven. An optical clad layer is thereby formed. The composition and procedure of Example 2 is followed using the optical clad layer of this example in place of the epoxy laminate to give a clad-core construction. The admixture of this example is roller coated onto the clad-core construction and dried in air in a convection oven for 30 minutes at 90° C. followed by a hard-cure at 200° C. for 60 minutes in air in a convection oven. A clad-core-clad optical waveguide is thereby formed.

### EXAMPLES 19-24

The procedure of Examples 17 and 18 are repeated, except groups B, C and D in the table below are substituted for group A.

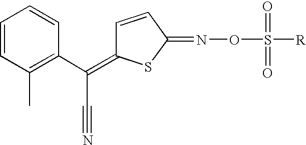

| Group (Examples) | R |
|---|---|
| A (Ex. 17-18) | n-propyl |
| B (Ex. 19-20) | n-octyl |
| C (Ex. 21-22) | Camphor |
| D (Ex. 23-24) | p-tolyl |

What is claimed is:

1. A photosensitive composition suitable for use in forming an optical waveguide, comprising:
a polymer comprising units of the formula (RSiO_{1.5}), wherein R is a substituted or unsubstituted organic group;
a photoactive component for altering the solubility of the polymer upon exposure to actinic radiation, wherein the photoactive component is non-ionic and has an associated wavelength of maximum absorption of greater than 300 nm.

2. The photosensitive composition of claim 1, wherein the photoactive component is a compound of the formula: 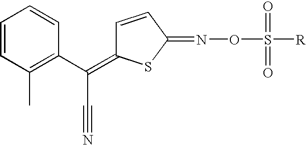
wherein R is a substituted or unsubstituted organic group.

3. The photosensitive composition of claim 2, wherein R is C1-C10 n-alkyl, Camphor or p-tolyl.

4. The photosensitive composition of claim 2, wherein the polymer further comprises units of the formula (R¹SiO_{1.5}), wherein R is a substituted or unsubstituted alkyl group and R¹ is a substituted or unsubstituted aryl group.

5. A method of forming an optical waveguide, comprising:
(a) forming over a substrate a layer of a photosensitive composition, comprising: units of the formula (RSiO_{1.5}), wherein R is a substituted or unsubstituted organic group; and a photoactive component for altering the solubility of the polymer upon exposure to actinic radiation, wherein the photoactive component is non-ionic and has an associated wavelength of maximum absorption of greater than 300 nm; and
(b) exposing the layer to actinic radiation having a wavelength greater than 300 nm.

6. The method of claim 5, wherein the photoactive component is a compound of the formula: 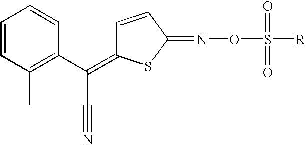
wherein R is a substituted or unsubstituted organic group.

7. The method of claim 6, wherein R is wherein R is C1-C10 n-alkyl, Camphor or p-tolyl.

8. The method of claim 6, further comprising developing the exposed layer to form a patterned structure.

9. The method of claim 6, wherein the actinic radiation has a wavelength of 365 nm.

10. An optical waveguide formed by the method of claim 6.
